(19) United States
(12) Patent Application Publication
(10) Pub. No.: US 2020/0296021 A1
(43) Pub. Date: Sep. 17, 2020

(54) ANALYSIS APPARATUS AND ANALYSIS METHOD

(71) Applicant: FUJITSU LIMITED, Kawasaki-shi (JP)

(72) Inventor: NAOYOSHI OHKAWA, Kawasaki (JP)

(73) Assignee: FUJITSU LIMITED, Kawasaki-shi (JP)

(21) Appl. No.: 16/799,098

(22) Filed: Feb. 24, 2020

(30) Foreign Application Priority Data
Mar. 12, 2019 (JP) 2019-044672

(51) Int. Cl. H04L 12/26

(52) U.S. Cl. CPC H04L 43/0864; H04L 43/106; H04L 43/04

(57) ABSTRACT

A non-transitory computer-readable recording medium has stored a program that causes a computer to execute a process including: capturing transmission packets transmitted from a first apparatus to a second apparatus, and response packets including a timestamp counted at an interval; estimating the interval based on arrival times of two response packets and timestamps thereof; estimating a count time of a first timestamp of a first response packet, based on a first arrival time of one transmission packet, a second arrival time of the first response packet, and the first timestamp; calculating a reference time based on the count time, the first timestamp, and the interval; estimating a transmission time of the first response packet, based on the reference time, the first timestamp, and the interval; and estimating a communication time of the first response packet, based on the transmission time and the second arrival time.

### CROSS-REFERENCE TO RELATED APPLICATION

This application is based upon and claims the benefit of priority of the prior Japanese Patent Application No. 2019-44672, filed on Mar. 12, 2019, the entire contents of which are incorporated herein by reference.

### FIELD

The embodiment discussed herein is related to an analysis apparatus and an analysis method.

### BACKGROUND

There has been disclosed a technique for capturing a plurality of packets transmitted and received between a user terminal and a server, and calculating a round-trip time from the captured packets. There has also been disclosed a technique, which utilizes the aforementioned technique, for identifying a type of a network to which a transmission source internet protocol (IP) address included in a packet transmitted to a server is to be connected, when the calculated round-trip time exceeds a reference value.

There has also been disclosed a technique for calculating an effective throughput from Transmission Control Protocol (TCP) window size and a round-trip time, and adjusting a residence time of a packet in a queue for temporarily accumulating packets in accordance with the calculated effective throughput.

Related techniques are disclosed in, for example, Japanese Laid-open Patent Publication No. 2013-115824 and Japanese Laid-open Patent Publication No. 2015-106880.

In the above-described technique for calculating a round-trip time, the round-trip time may be obtained from arrival times of a packet transmitted from a first communication apparatus and a packet replied from a second communication apparatus respectively arrived at an observation apparatus for capturing the packets. In other words, a communication time for a communication section that is a round trip between the observation apparatus and the second communication apparatus may be obtained.

However, in the above-mentioned technique for calculating a round-trip time, it is difficult to obtain detailed communication times for respective communication sections, such as a communication section of a forward path from the observation apparatus to the second communication apparatus, and a communication section of a return path from the second communication apparatus to the observation apparatus.

### SUMMARY

According to an aspect of the embodiment, a non-transitory computer-readable recording medium has stored therein a program that causes a computer to execute a process, the process including: capturing a plurality of transmission packets transmitted from a first communication apparatus to a second communication apparatus, and a plurality of response packets transmitted to the first communication apparatus from the second communication apparatus, the plurality of response packets respectively corresponding to the plurality of transmission packets, each of the plurality of response packets including a timestamp value counted at a time interval in the second communication apparatus; estimating the time interval based on arrival times of respective two response packets arriving at the computer among the plurality of response packets and timestamp values included in the respective two response packets; estimating a count time at which a first timestamp value included in a first response packet among the plurality of response packets is counted, based on a first arrival time of one transmission packet arriving at the computer among the plurality of transmission packets, a second arrival time of the first response packet arriving at the computer, and the first timestamp value; calculating a reference time based on the estimated count time, the first timestamp value, and the estimated time interval; estimating a transmission time at which the first response packet is transmitted in the second communication apparatus, based on the reference time, the first timestamp value, and the estimated time interval; estimating a first communication time of a first transmission packet corresponding to the first response packet from the computer to the second communication apparatus, based on a third arrival time of the first transmission packet arriving at the computer and the estimated transmission time; and estimating a second communication time of the first response packet from the second communication apparatus to the computer, based on the estimated transmission time and the second arrival time.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of an analysis system according to an embodiment;

FIG. 2 is the diagram for explaining processing of an analysis apparatus according to the embodiment;

FIG. 3 is a diagram illustrating a functional configuration of the analysis apparatus according to the embodiment;

FIG. 4 is a diagram illustrating an example of a packet information table according to the embodiment;

FIG. 5 is a diagram illustrating an example of an analysis information table according to the embodiment;

FIG. 6 is a diagram for explaining a measurement RTT according to the embodiment;

FIG. 7 is a diagram for explaining a count-up interval according to the embodiment;

FIG. 8 is a diagram for explaining a time difference between respective arrival times of a response packet and a transmission packet arriving at the analysis apparatus, according to the embodiment;

FIG. 9 is a diagram for explaining a communication time to be estimated according to the embodiment;

FIG. 10 is a diagram illustrating an example of a screen for displaying information indicating a communication section for which a communication time exceeds a threshold value, according to the embodiment;

FIG. 11 is a diagram illustrating a configuration of a computer that functions as the analysis apparatus according to the embodiment;

FIG. 12 is a flowchart illustrating an example of analysis processing according to the embodiment;

FIG. 13 is a flowchart illustrating an example of reference RTT calculation processing according to the embodiment;

FIG. 14 is a flowchart illustrating an example of reference time calculation processing according to the embodiment;

FIG. 15 is a flowchart illustrating an example of communication time estimation processing according to the embodiment;

FIG. 16 is a diagram illustrating an example of an estimation result of a communication time according to the embodiment; and

FIG. 17 is a diagram illustrating an example of a state in which a value to be counted up is not counted up, according to the embodiment.

### DESCRIPTION OF EMBODIMENT

Hereinafter, an embodiment of a technique to be disclosed will be described in detail with reference to the accompanying drawings. In the following, a description will be given of an example of the embodiment in which the technique to be disclosed is applied to an analysis apparatus for analyzing a packet for communication according to TCP.

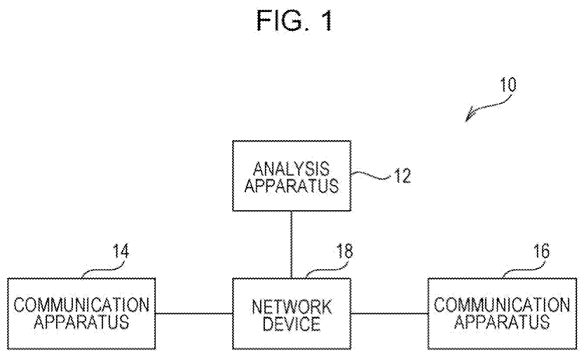

With reference to FIG. 1, a configuration of an analysis system 10 according to the present embodiment will be described. As illustrated in FIG. 1, the analysis system 10 includes an analysis apparatus 12, a communication apparatus 14, a communication apparatus 16, and a network device 18. Examples of the communication apparatus 14 and the communication apparatus 16 include information processing apparatuses such as a personal computer and a server computer, devices capable of communicating in accordance with TCP, for example, network devices such as a switching hub and a router, and the like. Communication between the communication apparatus 14 and the communication apparatus 16 is performed in accordance with TCP.

The network device 18 is provided on a communication path between the communication apparatus 14 and the communication apparatus 16, copies packets communicated between the communication apparatus 14 and the communication apparatus 16, and transmits the copied packets to the analysis apparatus 12. Examples of the network device 18 include a terminal access point (TAP), a switching hub having a port mirroring function, and the like.

The analysis apparatus 12 is coupled to the network device 18, receives packets communicated between the communication apparatus 14 and the communication apparatus 16 from the network device 18, and performs analysis by using the received packets. In other words, for example, in the present embodiment, the analysis apparatus 12 also serves as an observation apparatus for capturing packets communicated between the communication apparatus 14 and the communication apparatus 16. Examples of the analysis apparatus 12 include an information processing apparatus such as a server computer. In the following, for the sake of clarity, a description will be given as an example of a case in which the communication apparatus 14 is a first communication apparatus that transmits a packet containing data to be transmitted. In the following, a description will be given as an example of a case in which the communication apparatus 16 is a second communication apparatus that receives the packet transmitted from the communication apparatus 14, and transmits a packet indicating that the aforementioned packet is successfully received to the communication apparatus 14.

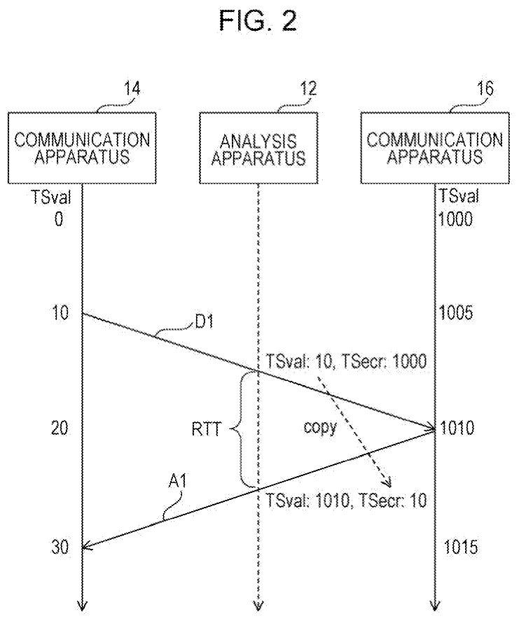

Next, before describing functions of the analysis apparatus 12 in detail, processing to be performed by the analysis apparatus 12 will be described with reference to FIG. 2.

As illustrated in FIG. 2, the communication apparatus 14 transmits a packet D1 containing data to the communication apparatus 16 in accordance with TCP. When successfully receiving the packet D1 transmitted from the communication apparatus 14, the communication apparatus 16 transmits a packet A1 corresponding to the packet D1 to the communication apparatus 14. In the following description, a packet transmitted from the communication apparatus 14 to the communication apparatus 16 in accordance with TCP is referred to as a “transmission packet”, and a packet as a response to the communication apparatus 14 from the communication apparatus 16 is referred to as a “response packet”. The response packet is specifically a TCP acknowledgment (ACK) packet. The transmission packet and the response packet are copied by the network device 18 and transmitted to the analysis apparatus 12.

As illustrated in FIG. 2, the analysis apparatus 12 may measure a round-trip time (RTT), by calculating a difference between respective arrival times of a response packet and a transmission packet corresponding to the response packet arriving at the analysis apparatus 12. The RTT may provide a communication time for a communication section that form a round trip between the communication apparatus 16 and the analysis apparatus 12, but not provide respective communication times for a communication section from the analysis apparatus 12 to the communication apparatus 16 and a communication section from the communication apparatus 16 to the analysis apparatus 12.

When a transmission time of the response packet in the communication apparatus 16 is obtained, the analysis apparatus 12 may obtain a communication time for the communication section from the analysis apparatus 12 to the communication apparatus 16, based on a difference between the transmission time and the arrival time of the transmission packet arriving at the analysis apparatus 12. In this case, the analysis apparatus 12 may also obtain a communication time for the communication section from the communication apparatus 16 to the analysis apparatus 12, based on a difference between the arrival time of the response packet arriving at the analysis apparatus 12 and the transmission time.

A header of a TCP packet includes a timestamp value (TSval) and a timestamp echo reply (TSecr) as timestamp options in TCP. The TSval is a value that is counted up at a predetermined time interval in a communication apparatus that is a transmission source of a TCP packet. When the communication apparatus 14 transmits a transmission packet, TSval corresponding to a system time of the communication apparatus 14 is inserted into a header of the transmission packet. When the communication apparatus 16 transmits a response packet, TSval corresponding to a system time of the communication apparatus 16 is inserted into a header of the response packet. When the communication apparatus 16 transmits the response packet, TSval included in the transmission packet corresponding to the response packet is copied to TSecr of the response packet.

Thus, the analysis apparatus 12 may refer to TSval included in the response packet, to obtain TSval at timing when the communication apparatus 16 transmits the response packet. However, the analysis apparatus 12 may not obtain a system time of the communication apparatus 16 corresponding to that TSval from the response packet.

Thus, the analysis apparatus 12 according to the present embodiment estimates a transmission time of a response packet in the communication apparatus 16, by using TSval of the response packet. By using the estimated transmission time, the analysis apparatus 12 estimates a communication time of a transmission packet from the analysis apparatus 12 to the communication apparatus 16, and a communication time of the response packet from the communication apparatus 16 to the analysis apparatus 12.

TSval is a value that is counted up at a predetermined time interval, but the time interval is not strictly defined in Request for Comments (RFC) 1323, and may be different depending on operating systems (OS). The time interval at which TSval is counted up may vary depending on versions even for the same OS.

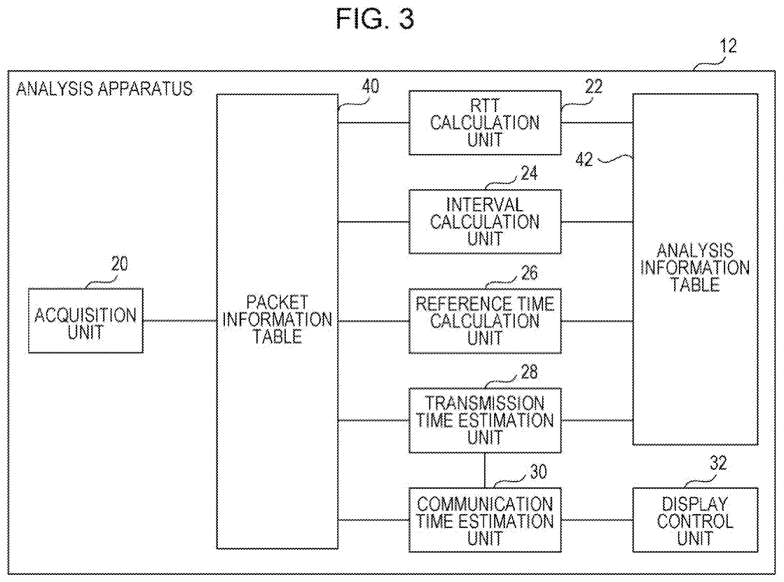

Next, with reference to FIG. 3, a functional configuration of the analysis apparatus 12 according to the present embodiment will be described. As illustrated in FIG. 3, the analysis apparatus 12 includes an acquisition unit 20, an RTT calculation unit 22, an interval calculation unit 24, a reference time calculation unit 26, a transmission time estimation unit 28, a communication time estimation unit 30, and a display control unit 32. A packet information table 40 and an analysis information table 42 are stored in a predetermined storage area of the analysis apparatus 12.

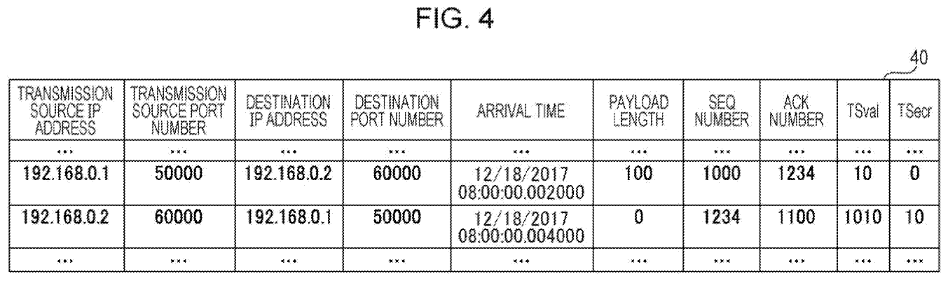

FIG. 4 illustrates an example of the packet information table 40. The packet information table 40 is a table in which information about a packet transmitted from the network device 18 to the analysis apparatus 12 is registered.

As illustrated in FIG. 4, a transmission source IP address, a transmission source port number, a destination IP address, and a destination port number of a packet are included in the packet information table 40. The packet information table 40 also includes an arrival time at the analysis apparatus 12, a payload length, a sequence number (denoted as a “seq number” in FIG. 4), an ACK number, TSval, and TSecr of the packet. In the following description, an arrival time of a packet arriving at the analysis apparatus 12 will be simply referred to as an “arrival time”.

A response packet corresponding to a transmission packet includes, as a destination IP address and a destination port number, a transmission source IP address and a transmission source port number of the transmission packet, respectively. A response packet corresponding to a transmission packet includes, as a transmission source IP address and a transmission source port number of, a destination IP address and a destination port number of the transmission packet, respectively. A response packet corresponding to a transmission packet includes, as a sequence number, an ACK number of the transmission packet. A response packet corresponding to a transmission packet includes, as an ACK number, a value obtained by adding a payload length of the transmission packet to a sequence number of the transmission packet. A response packet corresponding to a transmission packet includes, as TSecr, TSval of the transmission packet. Thus, the analysis apparatus 12 may associate, based on the information registered in the packet information table 40, a transmission packet with a response packet corresponding to the transmission packet.

The packet information table 40 may be constituted, for example, for each combination of a transmission source IP address, a transmission source port number, a destination IP address, and a destination port number, from separate tables.

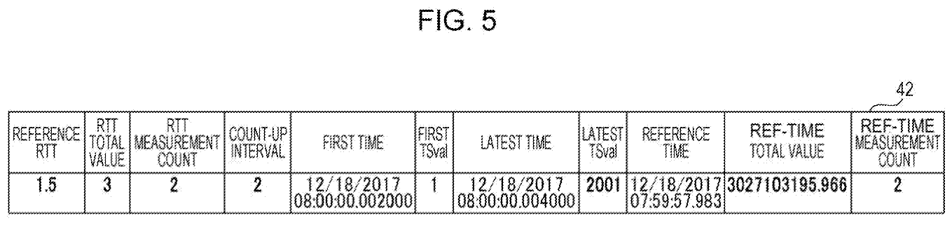

FIG. 5 illustrates an example of the analysis information table 42. The analysis information table 42 is a table in which information used by the analysis apparatus 12 for estimating detailed communication times for respective communication sections is registered.

As illustrated in FIG. 5, the analysis information table 42 includes, a reference value of RTT (hereinafter referred to as a “reference RTT”), a total value of RTT (hereinafter referred to as a “RTT total value”), and a measurement count of RTT (hereinafter referred to as a “RTT measurement count”), to be described later. The analysis information table 42 also includes a time interval at which TSval is counted up (hereinafter referred to as a “count-up interval”), a time at which TSval is acquired for the first time (denoted as an “first time” in FIG. 5), and TSval acquired for the first time (denoted as “first TSval” in FIG. 5). The analysis information table 42 further includes a time at which latest TSval is acquired (denoted as “latest time” in FIG. 5), the acquired latest TSval (denoted as “latest TSval” in FIG. 5), a reference time, a total value of reference time (hereinafter referred to as a “ref-time total value”), and a measurement count of reference time (hereinafter referred to as a “ref-time measurement count”). In the present embodiment, as a UNIX (registered trademark) time for example, an elapsed time with respect to a certain point in time is registered in the ref-time total value column. In the present embodiment, an initial value of each column of the analysis information table 42 is set to 0.

The acquisition unit 20 acquires a packet communicated between the communication apparatus 14 and the communication apparatus 16 from the network device 18. The acquisition unit 20 registers a transmission source IP address, a transmission source port number, a destination IP address, and a destination port number of the acquired packet in the packet information table 40. The acquisition unit 20 registers a time at which the packet is acquired in the packet information table 40 as an arrival time of the packet. The acquisition unit 20 registers a payload length, a sequence number, an ACK number, TSval, and TSecr of the acquired packet in the packet information table 40. In the present embodiment, the acquisition unit 20 adds the information about the packet described above to the packet information table 40 every time a packet is acquired.

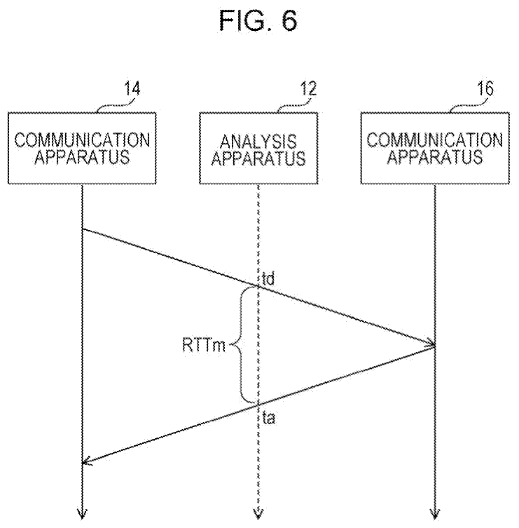

As illustrated in FIG. 6, when information about a response packet having a payload length of 0 is registered in the packet information table 40, the RTT calculation unit 22 measures an RTT that is a time difference between respective arrival times of a response packet and a transmission packet corresponding to the response packet. Hereinafter, the RTT described above will be referred to as a “measurement RTT”. Specifically, for example, the RTT calculation unit 22 measures an RTT by calculating RTTm in accordance with an expression (1) illustrated below. RTTm in the expression (1) indicates a measurement RTT, to indicates an arrival time of a response packet, and td indicates an arrival time of a transmission packet corresponding to the response packet.

RTTm=ta−td (1)

The RTT calculation unit 22, when a measurement RTT is measured for the first time, in the analysis information table 42, registers the measurement RTT in an RTT total value column and a reference RTT column, and registers 1 in an RTT measurement count column. When the measurement RTT is measured for the second time or later, and the measurement RTT is larger than the reference RTT, the RTT calculation unit 22 does not update the analysis information table 42.

When the measurement RTT is measured for the second time or later, and the measurement RTT is smaller than ½ of the reference RTT, the RTT calculation unit 22, as in the first measurement time, registers the measurement RTT in the RTT total value column and the reference RTT column of the analysis information table 42, and registers 1 in the RTT measurement count column. Specifically, for example, since the measurement RTT is much smaller than the reference RTT, the reference RTT is reset. The RTT calculation unit 22 may reset the reference RTT, for example, when the measurement RTT is smaller than ⅓ of the reference RTT, or the like, rather than when the measurement RTT is smaller than ½.

When the measurement RTT is measured for the second time or later, and the measurement RTT is equal to or more than ½ of the reference RTT and is equal to or smaller than the reference RTT, the RTT calculation unit 22 adds the measurement RTT to the RTT total value column and adds 1 to the RTT measurement count column, in the analysis information table 42.

The RTT calculation unit 22 calculates an average value of measurement RTT by dividing the RTT total value by the RTT measurement count in the analysis information table 42, and updates the reference RTT in the analysis information table 42 to the calculated average value.

When information about a response packet is registered in the packet information table 40 for the first time, the interval calculation unit 24 registers an arrival time of the response packet in the first time column of the analysis information table 42. In this case, the interval calculation unit 24 registers TSval of the response packet in the first TSval column of the analysis information table 42. This first response packet is an example of a first packet of the technique to be disclosed.

When information about the response packet is registered in the packet information table 40 for the second time or later, the interval calculation unit 24 performs the following processing. In this case, for example, when TSval of the response packet is a value counted up by a predetermined value (for example, 2000) or more from the first TSval in the analysis information table 42, the interval calculation unit 24 registers an arrival time of the response packet in the latest time column of the analysis information table 42. In this case, the interval calculation unit 24 registers TSval of the response packet in the latest TSval column of the analysis information table 42. The response packet for which TSval has been counted up by the predetermined value or more from the first TSval is an example of a second packet of the technique to be disclosed.

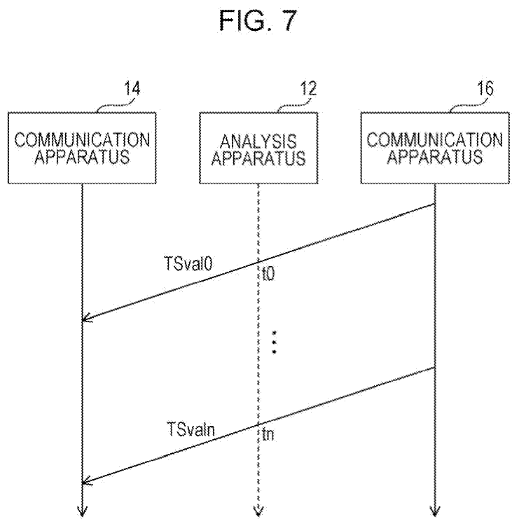

The interval calculation unit 24 calculates a count-up interval in accordance with the following expression (2), by using the first TSval, the first time, the latest TSval, and the latest time in the analysis information table 42. As illustrated in FIG. 7, in the expression (2), TSval0 is TSval of a first response packet that is registered in the packet information table 40 for the first time, and t0 indicates an arrival time of the first response packet. In the expression (2), TSvaln indicates TSval of a latest response packet for which TSval has been counted up by the predetermined value or more from TSval0, and tn indicates an arrival time of the latest response packet. In the expression (2), step is a count-up interval.

step=(tn−t0)/(TSvaln−TSval0) (2)

The interval calculation unit 24 registers the calculated count-up interval in the analysis information table 42.

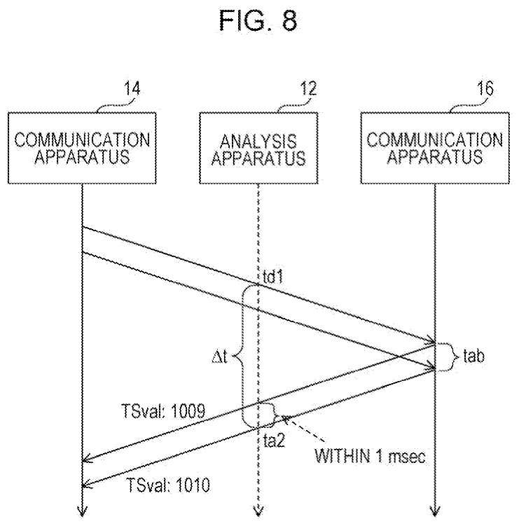

When a packet registered in the packet information table 40 is a response packet having a payload length of 0, and is a packet for which TSval has been counted up within a predetermined period (for example, 1 msec), the reference time calculation unit 26 performs the following processing. In this case, as illustrated in FIG. 8, the reference time calculation unit 26 calculates, in accordance with the following expression (3), a time difference Δt between an arrival time ta2 of the response packet described above, and an arrival time td1 of a transmission packet corresponding to a response packet before TSval is counted up. In this case, for example, the predetermined period described above is determined in advance in accordance with an order of a communication time to be estimated by the analysis apparatus 12. For example, when a user wants the analysis apparatus 12 to estimate a communication time in units of 1 msec, the predetermined period is set to 1 msec. A response packet for which TSval has been counted up within a predetermined period means a packet for which TSval has been counted up from a previous response packet, and which has an arrival time that differs from an arrival time of the previous response packet within the predetermined period.

Δt=ta2−td1 (3)

When the time difference Δt is equal to or smaller than a value obtained by adding a predetermined margin to the reference RTT registered in the analysis information table 42, the reference time calculation unit 26 calculates, in accordance with the following expression (4), an average time tavg of the arrival time td1 and the arrival time ta2. In the present embodiment, the reference time calculation unit 26 calculates the average time tavg, when the time difference Δt is equal to or smaller than a value obtained by adding a margin (for example, 1 msec) corresponding to an order of a communication time to be estimated by the analysis apparatus 12 to the reference RTT. For example, the reference time calculation unit 26 may calculate the average time tavg, when the time difference Δt is equal to or smaller than a value obtained by multiplying the reference RTT by a predetermined multiplying factor (for example, 1.1).

tavg=(td1+ta2)/2 (4)

The reason why the average time tavg is calculated as described above is as follows. As illustrated in FIG. 8, TSval is counted up in the communication apparatus 16 during a period between respective transmission times in the communication apparatus 16 of a response packet for which TSval has been counted up, and a response packet before TSval is counted up (a period of tab in FIG. 8). In other words, for example, the average time tavg of the arrival time td1 and the arrival time ta2 is highly likely to be a time within the period tab during which TSval is counted up. For this reason, in the present embodiment, the average time tavg is calculated as a time at which TSval is estimated to be counted up in the communication apparatus 16.

When the time difference Δt exceeds the value obtained by adding the predetermined margin to the reference RTT, the reference time calculation unit 26 does not calculate the average time tavg. This is because, for example, there is a high possibility of being largely influenced by a processing time due to other than a network, such as a delay of processing performed by the communication apparatus 16 in a period from reception of a transmission packet to response.

The reference time calculation unit 26 calculates a ref-time offsetm of TSval of a current response packet in accordance with the following expression (5), by using the calculated average time tavg, the counted-up TSval, and the count-up interval step. As illustrated in the expression (5), in the present embodiment, a system time of the communication apparatus 16 when TSval is 0 is calculated as the ref-time offsetm.

offsetm=tavg−TSval×step (5)

The reference time calculation unit 26 adds the calculated ref-time offsetm to the ref-time total value in the analysis information table 42, and adds 1 to a ref-time measurement count in the analysis information table 42. The reference time calculation unit 26 calculates an average value of reference times of respective response packets by dividing the ref-time total value by the ref-time measurement count in the analysis information table 42, and registers the average value in the reference time column of the analysis information table 42 as a reference time of TSval.

When it is known in advance, by performing a test or the like, that a time at which the communication apparatus 16 counts up TSval has a tendency to be earlier or later than the average time tavg, a reference time may be calculated by using a time obtained by adding a margin to the average time tavg.

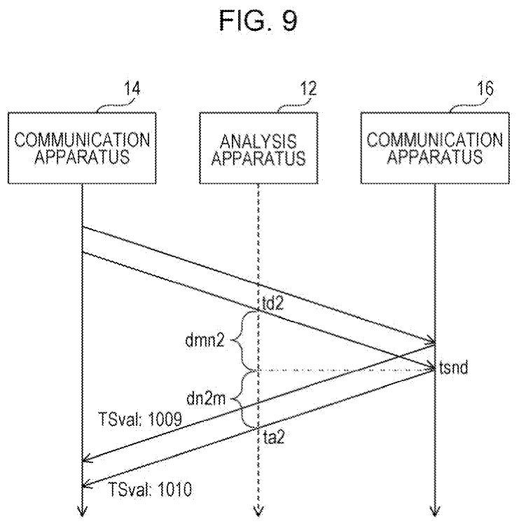

When a packet registered in the packet information table 40 is a response packet having a payload length of 0, and is a packet for which TSval has been counted up within a predetermined period, the transmission time estimation unit 28 performs the following processing. In this case, as illustrated in FIG. 9, the transmission time estimation unit 28 estimates a transmission time of the response packet in the communication apparatus 16 in accordance with the following expression (6), by using a reference time, TSval of a response packet, and a count-up interval. In the expression (6), tsnd indicates a transmission time of the response packet in the communication apparatus 16, and offset indicates a reference time registered in the analysis information table 42. Step in the expression (6) indicates a count-up interval registered in the analysis information table 42.

tsnd=offset+TSval×step (6)

The communication time estimation unit 30 estimates, by using the transmission time estimated by the transmission time estimation unit 28, a communication time of a transmission packet from the analysis apparatus 12 to the communication apparatus 16, and a communication time of a response packet from the communication apparatus 16 to the analysis apparatus 12. Specifically, for example, the communication time estimation unit 30 subtracts an arrival time td2 of a transmission packet corresponding to a response packet from the transmission time tsnd in accordance with the following expression (7), thereby calculating a communication time dmn2 of the transmission packet from the analysis apparatus 12 to the communication apparatus 16.

dmn2=tsnd−td2 (7)

The communication time estimation unit 30 subtracts the transmission time tsnd from the arrival time ta2 of a response packet in accordance with the following expression (8), thereby calculating a communication time dn2m of the response packet from the communication apparatus 16 to the analysis apparatus 12.

dn2m=ta2−tsnd (8)

The communication time estimation unit 30 stores the estimated communication time dmn2 and the estimated communication time dn2m in a predetermined storage area of the analysis apparatus 12, in association with respective communication sections and arrival times. The stored information may be used as statistical information, or may be used to isolate a cause of a communication delay.

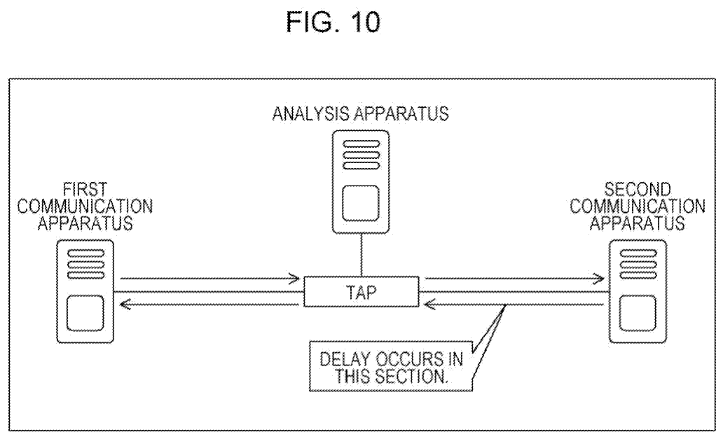

When the communication time estimated by the communication time estimation unit 30 exceeds a threshold value, the display control unit 32 performs control for displaying information indicating a communication section for which a communication time exceeds the threshold value on a display unit of an input/output unit 64 to be described later. In the present embodiment, when the communication time dmn2 or the communication time dn2m estimated by the communication time estimation unit 30 exceeds the threshold value, the display control unit 32 performs control for displaying information indicating a communication section for which the communication time exceeds the threshold value on the display unit of the input/output unit 64. Specifically, as illustrated in FIG. 10, the display control unit 32 performs control for displaying that a delay occurs in a communication section for which a communication time exceeds the threshold value, on the display unit of the input/output unit 64, in a visually recognizable manner. FIG. 10 illustrates an example of a case in which the communication time dn2m exceeds the threshold value. The display control unit 32 may perform control for displaying a communication section for which a communication time exceeds the threshold value by a character notation.

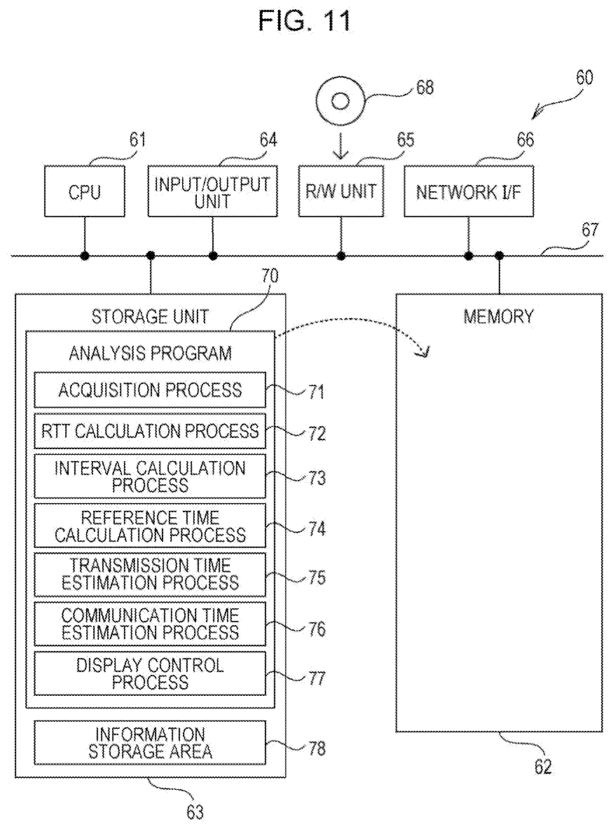

The analysis apparatus 12 may be implemented, for example, by a computer 60 illustrated in FIG. 11. The computer 60 includes a central processing unit (CPU) 61, a memory 62 serving as a temporary storage area, and a nonvolatile storage unit 63. The computer 60 includes the input/output unit 64 such as a display unit and an input unit. The computer 60 includes a read/write (R/W) unit 65 that controls reading and writing of data from and to a recording medium 68, and a network interface (I/F) 66 coupled to the network device 18. The CPU 61, the memory 62, the storage unit 63, the input/output unit 64, the R/W unit 65, and the network I/F 66 are coupled with each other via a bus 67.

The storage unit 63 may be implemented by a hard disk drive (HDD), a solid state drive (SSD), a flash memory, or the like. The storage unit 63 as a storage medium stores an analysis program 70 for causing the computer 60 to function as the analysis apparatus 12. The analysis program 70 includes an acquisition process 71, an RTT calculation process 72, an interval calculation process 73, a reference time calculation process 74, a transmission time estimation process 75, a communication time estimation process 76, and a display control process 77. The storage unit 63 includes an information storage area 78 in which the packet information table 40 and the analysis information table 42 are stored.

The CPU 61 reads the analysis program 70 from the storage unit 63 and loads the analysis program 70 into the memory 62 to execute the processes included in the analysis program 70. The CPU 61 operates as the acquisition unit 20 illustrated in FIG. 3 by executing the acquisition process 71. The CPU 61 operates as the RTT calculation unit 22 illustrated in FIG. 3 by executing the RTT calculation process 72. The CPU 61 operates as the interval calculation unit 24 illustrated in FIG. 3 by executing the interval calculation process 73. The CPU 61 operates as the reference time calculation unit 26 illustrated in FIG. 3 by executing the reference time calculation process 74. The CPU 61 operates as the transmission time estimation unit 28 illustrated in FIG. 3 by executing the transmission time estimation process 75. The CPU 61 operates as the communication time estimation unit 30 illustrated in FIG. 3 by executing the communication time estimation process 76. The CPU 61 operates as the display control unit 32 illustrated in FIG. 3 by executing the display control process 77. Thus, the computer 60 executing the analysis program 70 functions as the analysis apparatus 12. The CPU 61 that executes the processes included in the analysis program 70 is hardware.

The functions implemented by the analysis program 70 may be implemented by, for example, a semiconductor integrated circuit, more specifically, an application specific integrated circuit (ASIC) or the like.

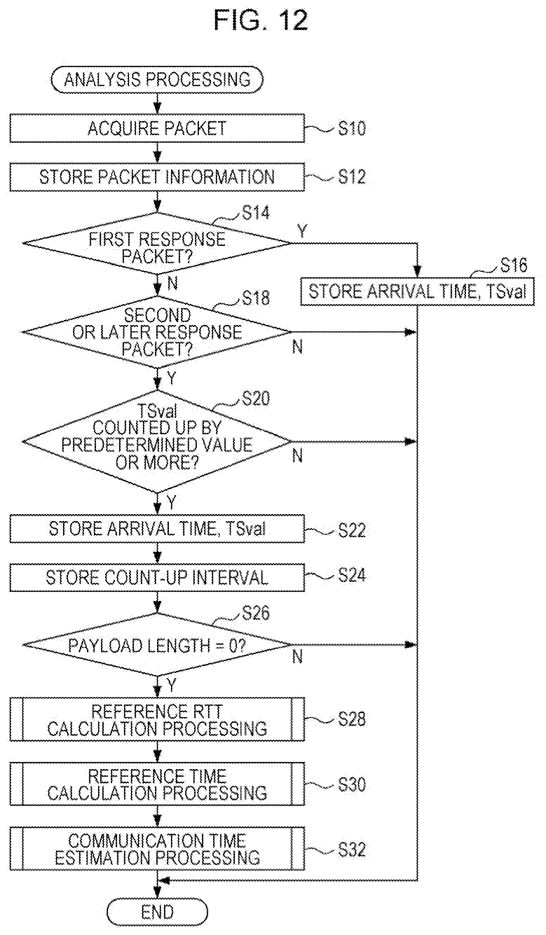

Next, operation of the analysis apparatus 12 according to the present embodiment will be described. The analysis apparatus 12 executes the analysis program 70, to perform analysis processing illustrated in FIG. 12. The analysis processing illustrated in FIG. 12 is performed, for example, each time the analysis apparatus 12 receives a packet communicated between the communication apparatus 14 and the communication apparatus 16 from the network device 18.

In S10 of FIG. 12, the acquisition unit 20 acquires a packet communicated between the communication apparatus 14 and the communication apparatus 16 from the network device 18. In S12, the acquisition unit 20 registers information about the packet acquired in S10 as described above in the packet information table 40.

In S14, the interval calculation unit 24 determines whether or not information about a response packet is registered for the first time in the packet information table 40 in S12. When this determination is positive, the processing proceeds to S16. In S16, the interval calculation unit 24 registers an arrival time of the response packet, which is registered in the packet information table 40 in S12, in the first time column of the analysis information table 42. The interval calculation unit 24 registers TSval of the response packet, which is registered in the packet information table 40 in S12, in the first TSVal column of the analysis information table 42. When the process in S16 ends, the analysis processing ends.

When the determination in S14 is negative, the processing proceeds to S18. In S18, the interval calculation unit 24 determines whether or not the information about the response packet is registered in the packet information table 40 for the second time or later in S12. When the determination is negative, the analysis processing ends, and when the determination is positive, the processing proceeds to S20.

In S20, the interval calculation unit 24 determines whether or not TSval of the response packet registered in the packet information table 40 in S12 is a value that is counted up by a predetermined value or more from the first TSval in the analysis information table 42. When the determination is negative, the analysis processing ends, and when the determination is positive, the processing proceeds to S22.

In S22, the interval calculation unit 24 registers the arrival time of the response packet, which is registered in the packet information table 40 in S12, in the latest time column of the analysis information table 42. The interval calculation unit 24 registers TSval of the response packet, which is registered in the packet information table 40 in S12, in the latest TSval column of the analysis information table 42.

In S24, the interval calculation unit 24 calculates a count-up interval in accordance with the expression (2) as described above, by using the first TSval, the first time, the latest TSval, and the latest time registered in the analysis information table 42. The interval calculation unit 24 registers the calculated count-up interval in the analysis information table 42.

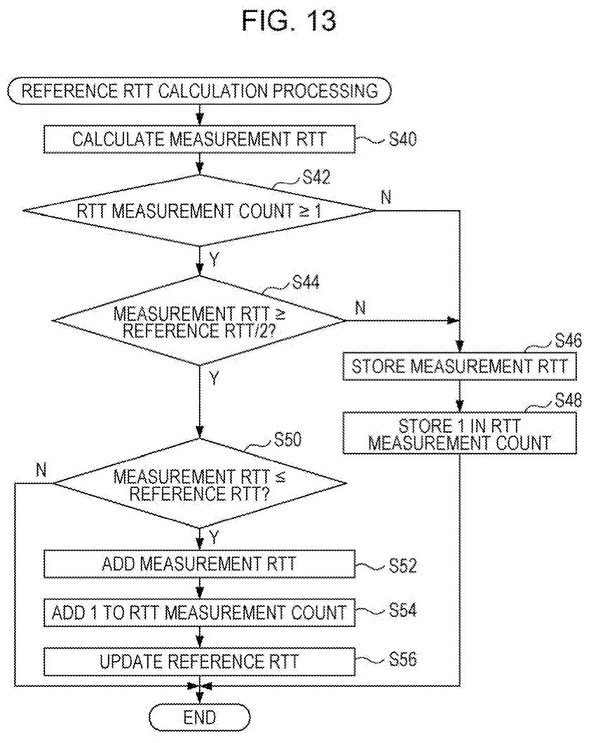

In S26, the RTT calculation unit 22 determines whether or not a payload length of the response packet registered in the packet information table 40 in S12 is 0. When the determination is negative, the analysis processing ends, and when the determination is positive, the processing proceeds to S28. In S28, reference RTT calculation processing illustrated in FIG. 13 is performed.

In S40 of FIG. 13, the RTT calculation unit 22 calculates a measurement RTT in accordance with the expression (1) as described above. In S42, the RTT calculation unit 22 determines whether or not an RTT measurement count registered in the analysis information table 42 is 1 or more. When the determination is negative, the processing proceeds to S46, and when the determination is positive, the processing proceeds to S44.

In S44, the RTT calculation unit 22 determines whether or not the measurement RTT calculated in S40 is equal to or more than ½ of the reference RTT registered in the analysis information table 42. When this determination is negative, the processing proceeds to S46. In S46, the RU calculation unit 22 registers the measurement RU, which is calculated in S40, in the RU total value column and the reference RU column of the analysis information table 42. In S48, the RU calculation unit 22 registers 1 in the RU measurement count column of the analysis information table 42. When the process in S48 ends, the reference RU calculation processing ends.

When the determination in S44 is positive, the processing proceeds to S50. In S50, the RU calculation unit 22 determines whether or not the measurement RU calculated in S40 is equal to or smaller than the reference RU registered in the analysis information table 42. When the determination is negative, the reference RU calculation processing ends, and when the determination is positive, the processing proceeds to S52.

In S52, the RU calculation unit 22 adds the measurement RU calculated in S40 to the RU total value column of the analysis information table 42. In S54, the RU calculation unit 22 adds 1 to the RU measurement count column of the analysis information table 42. In S56, the RU calculation unit 22 calculates an average value of measurement RU by dividing the RU total value by the RU measurement count registered in the analysis information table 42, and updates the reference RU in the analysis information table 42 to the calculated average value. When the process in S56 ends, the reference RU calculation processing ends.

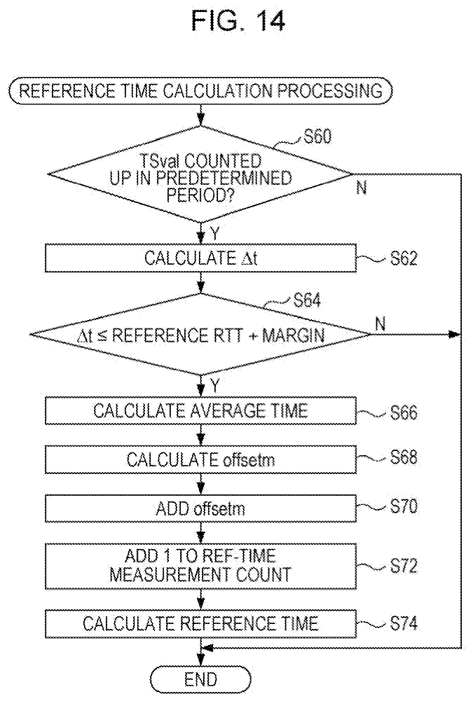

When the reference RTT calculation processing ends, the processing proceeds to S30 of FIG. 12. In S30, reference time calculation processing illustrated in FIG. 14 is performed.

In S60 of FIG. 14, the reference time calculation unit 26 determines whether or not the response packet registered in the packet information table 40 in S12 is a packet for which TSval has been counted up within a predetermined period. When the determination is negative, the reference time calculation processing ends, and when the determination is positive, the processing proceeds to S62. In S62, as described above, the reference time calculation unit 26 calculates, in accordance with the expression (3), the time difference Δt between the arrival time of the response packet for which TSval has been counted up and the arrival time of the transmission packet corresponding to the response packet before TSval is counted up.

In S64, the reference time calculation unit 26 determines whether or not the time difference Δt calculated in S62 is equal to or smaller than a value obtained by adding a margin to the reference RTT registered in the analysis information table 42. When the determination is negative, the reference time calculation processing ends, and when the determination is positive, the processing proceeds to S66.

In S66, as described above, the reference time calculation unit 26 calculates, in accordance with the expression (4), an average time of the arrival time of the response packet for which TSval has been counted up, and the arrival time of the transmission packet corresponding to the response packet before TSval is counted up.

In S68, the reference time calculation unit 26 calculates the ref-time offsetm of TSval of a current response packet in accordance with expression (5) as described above, by using the calculated average time, TSval of the counted-up response packet, and the count-up interval. In S70, the reference time calculation unit 26 adds the ref-time offsetm calculated in S68 to the ref-time total value column of the analysis information table 42. In S72, the reference time calculation unit 26 adds 1 to the ref-time measurement count column of the analysis information table 42.

In S74, the reference time calculation unit 26 calculates an average value of the reference times of the respective response packets by dividing the ref-time total value by the ref-time measurement count registered in the analysis information table 42. The reference time calculation unit 26 registers, as the reference time, the calculated average value in the reference time column of the analysis information table 42. When the process in S74 ends, the reference time calculation processing ends.

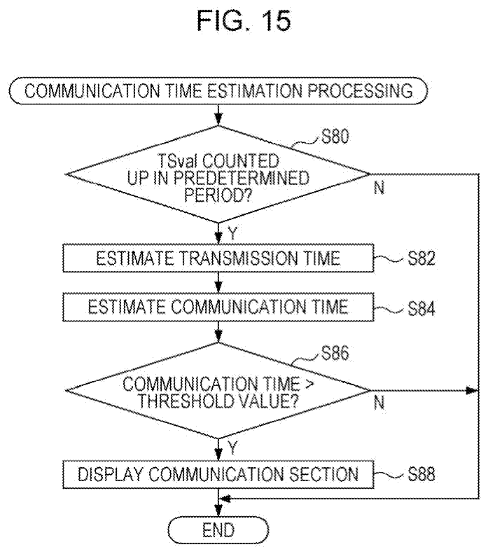

When the reference time calculation processing ends, the processing proceeds to S32 of FIG. 12. In S32, communication time estimation processing illustrated in FIG. 15 is performed.

In S80 of FIG. 15, the transmission time estimation unit 28 determines whether or not the response packet that is registered in the packet information table 40 in S12 is a packet for which TSval has been counted up within a predetermined period. When the determination is negative, the communication time estimation processing ends, and when the determination is positive, the processing proceeds to S82. In S82, the transmission time estimation unit 28 estimates a transmission time of the response packet in the communication apparatus 16 in accordance with the expression (6), by using the reference time, TSval of the response packet, and the count-up interval, registered in the analysis information table 42.

In S84, the communication time estimation unit 30 estimates a communication time of the transmission packet from the analysis apparatus 12 to the communication apparatus 16 in accordance with the expression (7), by using the transmission time estimated in S82 and the arrival time of the transmission packet corresponding to the response packet. The communication time estimation unit 30 estimates a communication time of the response packet from the communication apparatus 16 to the analysis apparatus 12 in accordance with the expression (8), by using the arrival time of the response packet and the transmission time estimated in S82. The communication time estimation unit 30 stores the estimated communication times in a predetermined storage area of the analysis apparatus 12 in association with respective communication sections and arrival times.

In S86, the display control unit 32 determines whether or not any of the two communication times estimated in S84 exceeds a threshold value. When the determination is negative, the communication time estimation processing ends, and when the determination is positive, the processing proceeds to S88.

In S88, as described above, the display control unit 32 performs control for displaying the information indicating the communication section for which the communication time exceeds the threshold value, on the display unit of the input/output unit 64. When the process in S88 ends, the communication time estimation processing ends. When the communication time estimation processing ends, the analysis processing illustrated in FIG. 12 ends.

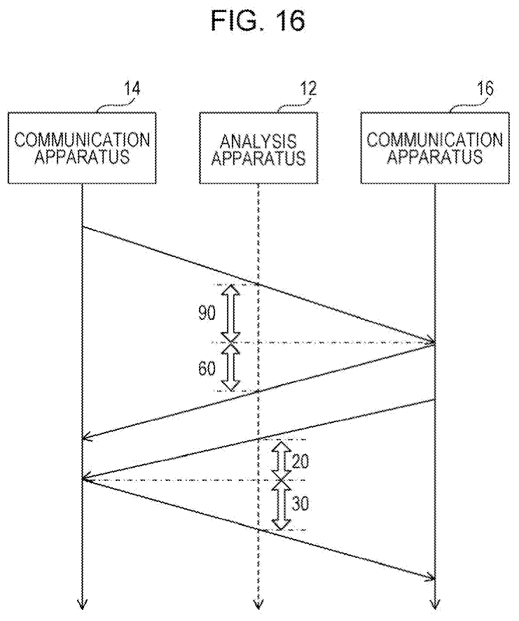

As described above, according to the present embodiment, as illustrated in FIG. 16, the communication time of the transmission packet from the analysis apparatus 12 to the communication apparatus 16 (“90” in FIG. 16) and the communication time of the response packet from the communication apparatus 16 to the analysis apparatus 12 (“60” in FIG. 16) are estimated. Thus, detailed communication times of respective communication sections may be estimated.

The analysis apparatus 12 may perform the analysis processing illustrated in FIG. 12 similarly when the communication apparatus 16 is the first communication apparatus that transmits a transmission packet, and the communication apparatus 14 is the second communication apparatus that transmits a response packet as well. In other words, for example, in this case, the analysis apparatus 12, as illustrated in FIG. 16, may estimate a communication time of a transmission packet from the analysis apparatus 12 to the communication apparatus 14 (“20” in FIG. 16), and a communication time of a response packet from the communication apparatus 14 to the analysis apparatus 12 (“30” in FIG. 16).

According to the present embodiment, a packet having a payload length of 0 is employed as a response packet. Thus, a communication time in which influence of a processing delay in the communication apparatus 16 is reduced may be estimated.

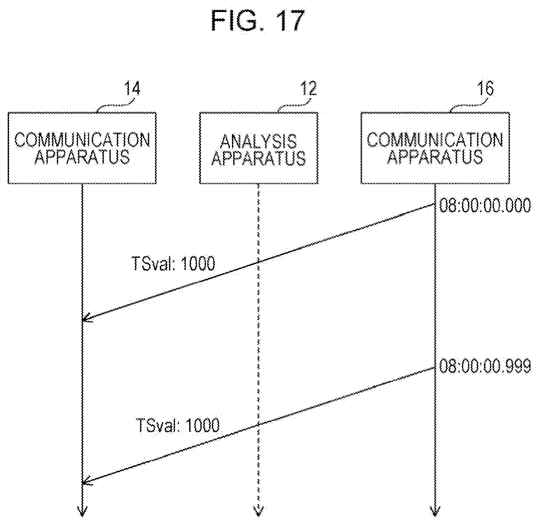

According to the present embodiment, a response packet for which TSval has been counted up within a predetermined period is used. As an example, as illustrated in FIG. 17, a count-up interval is relatively long in some cases. In this case, TSval is not counted up even after elapsing a time longer than an order of a communication time to be estimated by the analysis apparatus 12. Compared to this, as in the present embodiment, by using a response packet for which TSval has been counted up within a predetermined period, the communication time may be estimated with high accuracy even when a count-up interval of TSval is longer than an order of a communication time to be estimated.

According to the present embodiment, a timestamp value of a TCP timestamp option is employed as a value to be counted up. Thus, detailed communication times for respective communication sections may be estimated in accordance with standards commonly used, without special preparation or the like.

In the above-described embodiment, the case in which a communication time is estimated by using a packet for communication according to TCP is explained, but not limited thereto. For example, a modification may be adopted in which a communication time is estimated by using a packet for communication according to a communication protocol other than TCP. In this case, a modification is exemplified in which the communication apparatus 16 adds a value to be counted, which corresponds to TSval, to a response packet. In this modification example, the counted value may be a value to be counted down, rather than a value to be counted up.

In the above-described embodiment, the case is described in which the communication apparatus 16 estimates the average time tavg calculated in accordance with the expression (4) as the time at which TSval is counted up, but not limited thereto. For example, a modification may be adopted in which an average time of an arrival time of a response packet and an arrival time of a transmission packet corresponding to the response packet may be estimated as the time at which TSval is counted up, when it is known in advance that a count-up interval is a micro time interval.

In the above-described embodiment, the case in which the analysis processing illustrated in FIG. 12 is performed every time the analysis apparatus 12 acquires a packet, but not limited thereto. For example, among the processes in the analysis processing illustrated in FIG. 12, only the processes for registering the information about the packet acquired by the analysis apparatus 12 in the packet information table 40 (the processes in S10 and S12 illustrated in FIG. 12) may be executed every time the analysis apparatus 12 acquires a packet. In this case, a modification is exemplified in which the process in S14 and subsequent processes illustrated in FIG. 12 are executed at regular timing such as once a day or the like. In this modification example, the processes in S10 and S12, and the process in S14 and subsequent processes may be executed by separate information processing apparatuses.

In the above-described embodiment, each of the reference RTT, the count-up interval, and the reference time may be calculated, when used. In this case, the reference RTT, the count-up interval, and the reference time is not required to be registered in the analysis information table 42.

In the above-described embodiment, the case is described in which the count-up interval is calculated in the analysis processing, but not limited thereto. For example, when an OS and a version of the OS of the communication apparatus 16 are fixed, a modification may be adopted in which a count-up interval is measured in advance, and the measured count-up interval is stored in the analysis apparatus 12.

In the above-described embodiment, an aspect is described in which the analysis program 70 is stored (installed) in advance in the storage unit 63, but not limited thereto. The analysis program 70 may also be provided in a form of being recorded in a recording medium, such as a compact disc read-only memory (CD-ROM), a digital versatile disc (DVD)-ROM, a Universal Serial Bus (USB) memory, or a memory card.

According to an aspect of the embodiment, detailed communication times for respective communication sections may be estimated.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
capturing a plurality of transmission packets transmitted from a first communication apparatus to a second communication apparatus, and a plurality of response packets transmitted to the first communication apparatus from the second communication apparatus, the plurality of response packets respectively corresponding to the plurality of transmission packets, each of the plurality of response packets including a timestamp value counted at a time interval in the second communication apparatus;
estimating the time interval based on arrival times of respective two response packets arriving at the computer among the plurality of response packets and timestamp values included in the respective two response packets;
estimating a count time at which a first timestamp value included in a first response packet among the plurality of response packets is counted, based on a first arrival time of one transmission packet arriving at the computer among the plurality of transmission packets, a second arrival time of the first response packet arriving at the computer, and the first timestamp value;
calculating a reference time based on the estimated count time, the first timestamp value, and the estimated time interval;
estimating a transmission time at which the first response packet is transmitted in the second communication apparatus, based on the reference time, the first timestamp value, and the estimated time interval;
estimating a first communication time of a first transmission packet corresponding to the first response packet from the computer to the second communication apparatus, based on a third arrival time of the first transmission packet arriving at the computer and the estimated transmission time; and
estimating a second communication time of the first response packet from the second communication apparatus to the computer, based on the estimated transmission time and the second arrival time.

2. The non-transitory computer-readable recording medium according to claim 1, wherein
the estimated count time is an average time of the first arrival time and the second arrival time.

3. The non-transitory computer-readable recording medium according to claim 2, wherein
the one transmission packet is a transmission packet corresponding to a response packet including a timestamp value before the first timestamp value is counted.

4. The non-transitory computer-readable recording medium according to claim 1, wherein
a difference between the timestamp values included in the respective two response packets is equal to or more than a predetermined value.

5. The non-transitory computer-readable recording medium according to claim 1, wherein
a second response packet corresponding to the one transmission packet arrives at the computer earlier than the first response packet,
a time difference between an arrival time of the second response packet arriving at the computer and the second arrival time is within a predetermined time, and
the second response packet includes a timestamp value before the first timestamp is counted.

6. The non-transitory computer-readable recording medium according to claim 1, wherein
a time difference between the first arrival time and the second arrival time is equal to or less than a value obtained by adding a predetermined margin to a reference value of a round-trip time that is a time difference between respective arrival times of a transmission packet and a response packet corresponding to each other arriving at the computer.

7. The non-transitory computer-readable recording medium according to claim 6, the process further comprising:
measuring the round-trip time; and
updating the reference value to an average value of measured round-trip times when the measured round-trip time is equal to or less than the reference value.

8. The non-transitory computer-readable recording medium according to claim 1, the process further comprising:
performing, when the estimated first communication time exceeds a predetermined threshold value, control for displaying information indicating a communication section from the computer to the second communication apparatus on a display unit; and
performing, when the estimated second communication time exceeds the predetermined threshold value, control for displaying information indicating a communication section from the second communication apparatus to the computer on the display unit.

9. The non-transitory computer-readable recording medium according to claim 1, wherein
the first response packet is a packet having a payload length of 0.

10. The non-transitory computer-readable recording medium according to claim 1, wherein
each of the plurality of transmission packets is transmitted from the first communication apparatus in accordance with Transmission Control Protocol (TCP),
each of the plurality of response packets is a TCP acknowledgment (ACK) packet, and
the timestamp value included in each of the plurality of response packets is a timestamp value of a TCP timestamp option.

11. An analysis apparatus, comprising:
a memory; and
a processor coupled the memory and the processor configured to:
capture a plurality of transmission packets transmitted from a first communication apparatus to a second communication apparatus, and a plurality of response packets transmitted to the first communication apparatus from the second communication apparatus, the plurality of response packets respectively corresponding to the plurality of transmission packets, each of the plurality of response packets including a timestamp value counted at a time interval in the second communication apparatus;
estimate the time interval based on arrival times of respective two response packets arriving at the analysis apparatus among the plurality of response packets and timestamp values included in the respective two response packets;
estimate a count time at which a first timestamp value included in a first response packet among the plurality of response packets is counted, based on a first arrival time of one transmission packet arriving at the analysis apparatus among the plurality of transmission packets, a second arrival time of the first response packet arriving at the analysis apparatus, and the first timestamp value;
calculate a reference time based on the estimated count time, the first timestamp value, and the estimated time interval;
estimate a transmission time at which the first response packet is transmitted in the second communication apparatus, based on the reference time, the first timestamp value, and the estimated time interval;
estimate a first communication time of a first transmission packet corresponding to the first response packet from the analysis apparatus to the second communication apparatus, based on a third arrival time of the first transmission packet arriving at the analysis apparatus and the estimated transmission time; and
estimate a second communication time of the first response packet from the second communication apparatus to the analysis apparatus, based on the estimated transmission time and the second arrival time.

12. The analysis apparatus according to claim 11, wherein
the estimated count time is an average time of the first arrival time and the second arrival time.

13. The analysis apparatus according to claim 12, wherein
the one transmission packet is a transmission packet corresponding to a response packet including a timestamp value before the first timestamp value is counted.

14. The analysis apparatus according to claim 11, wherein
a difference between the timestamp values included in the respective two response packets is equal to or more than a predetermined value.

15. The analysis apparatus according to claim 11, wherein
a second response packet corresponding to the one transmission packet arrives at the analysis apparatus earlier than the first response packet,
a time difference between an arrival time of the second response packet arriving at the analysis apparatus and the second arrival time is within a predetermined time, and
the second response packet includes a timestamp value before the first timestamp is counted.

16. The analysis apparatus according to claim 11, wherein
a time difference between the first arrival time and the second arrival time is equal to or less than a value obtained by adding a predetermined margin to a reference value of a round-trip time that is a time difference between respective arrival times of a transmission packet and a response packet corresponding to each other arriving at the analysis apparatus.

17. The analysis apparatus according to claim 16, wherein
the processor is further configured to:
measure the round-trip time; and
update the reference value to an average value of measured round-trip times when the measured round-trip time is equal to or less than the reference value.

18. The analysis apparatus according to claim 11, wherein
the processor is further configured to:
perform, when the estimated first communication time exceeds a predetermined threshold value, control for displaying information indicating a communication section from the analysis apparatus to the second communication apparatus on a display unit; and
perform, when the estimated second communication time exceeds the predetermined threshold value, control for displaying information indicating a communication section from the second communication apparatus to the analysis apparatus on the display unit.

19. An analysis method, comprising:
capturing, by a computer, a plurality of transmission packets transmitted from a first communication apparatus to a second communication apparatus, and a plurality of response packets transmitted to the first communication apparatus from the second communication apparatus, the plurality of response packets respectively corresponding to the plurality of transmission packets, each of the plurality of response packets including a timestamp value counted at a time interval in the second communication apparatus;
estimating the time interval based on arrival times of respective two response packets arriving at the computer among the plurality of response packets and timestamp values included in the respective two response packets;
estimating a count time at which a first timestamp value included in a first response packet among the plurality of response packets is counted, based on a first arrival time of one transmission packet arriving at the computer among the plurality of transmission packets, a second arrival time of the first response packet arriving at the computer, and the first timestamp value;
calculating a reference time based on the estimated count time, the first timestamp value, and the estimated time interval;
estimating a transmission time at which the first response packet is transmitted in the second communication apparatus, based on the reference time, the first timestamp value, and the estimated time interval;
estimating a first communication time of a first transmission packet corresponding to the first response packet from the computer to the second communication apparatus, based on a third arrival time of the first transmission packet arriving at the computer and the estimated transmission time; and
estimating a second communication time of the first response packet from the second communication apparatus to the computer, based on the estimated transmission time and the second arrival time.
